(19) United States
(12) Patent Application Publication
(10) Pub. No.: US 2018/0263215 A1
(43) Pub. Date: Sep. 20, 2018

(54) PET TRAINING DEVICE

(71) Applicant: ANIMAL EXPERT, LLC, Agoura Hills, CA (US)

(72) Inventors: Brandon Parrish MCMILLAN, Los Angeles, CA (US); Jack RENFORTH, Azle, TX (US); Nicholas BAKER, Fort Worth, TX (US)

(21) Appl. No.: 15/909,357

(22) Filed: Mar. 1, 2018

Related U.S. Application Data
(60) Provisional application No. 62/473,709, filed on Mar. 20, 2017.

(51) Int. Cl. A01K 15/02

(52) U.S. Cl. CPC A01K 15/02; A01K 5/0114

(57) ABSTRACT

A pet training device includes a telescoping shaft and a clip portion. The clip portion generally has a first member and a second member pivotally connected to the first member such that an object can be held therebetween in an interior area. The second member includes a reservoir portion on an external surface that enables food to be disposed therein.

### CROSS REFERENCE TO RELATED APPLICATIONS

This application claims priority to U.S. Provisional Application No. 62/473,709, filed Mar. 20, 2017, the contents of which are hereby incorporated herein by reference.

### FIELD OF THE INVENTION

The present invention relates to a pet training device. In particular, the present invention relates to a pet training device that is capable of holding treats in a manner to lure pets.

### DESCRIPTION OF RELATED ART

Conventional pet training can include luring the pet. During luring training, the pet will follow closely with his nose. Generally, food is used to persuade the pet in a certain direction or to perform a certain activity. Additionally, Toys can also be used, but food is the simplest and most practical option.

### SUMMARY

It has been discovered that a more effective pet training device can include multiple portions for various objects or food to be used to lure. A pet training device according to one embodiment includes a telescoping shaft and a clip portion. The clip portion generally has a first member and a second member pivotally connected to the first member such that an object can be held therebetween in an interior area. The second member includes a reservoir portion on an external surface that enables food to be disposed therein.

### BRIEF DESCRIPTION OF THE DRAWINGS

Referring now to the attached drawings which form a part of this original disclosure:

FIG. 1 is a top perspective view of an embodiment of the present invention;

FIG. 2 is a front view of the embodiment shown in FIG. 1;

FIG. 3 is rear view of the embodiment shown in FIG. 1;

FIG. 4 is a side view of the embodiment shown in FIG. 1;

FIG. 5 is a top view of the embodiment shown in FIG. 1;

FIG. 6 is a bottom view of the embodiment shown in FIG. 1;

FIG. 7 is a cross section view taken along lines 7-7 in FIG. 2;

FIG. 8 is a top perspective view of the embodiment shown in FIG. 1 in a retracted position; and

FIG. 9 is an enlarged view of the clip portion.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

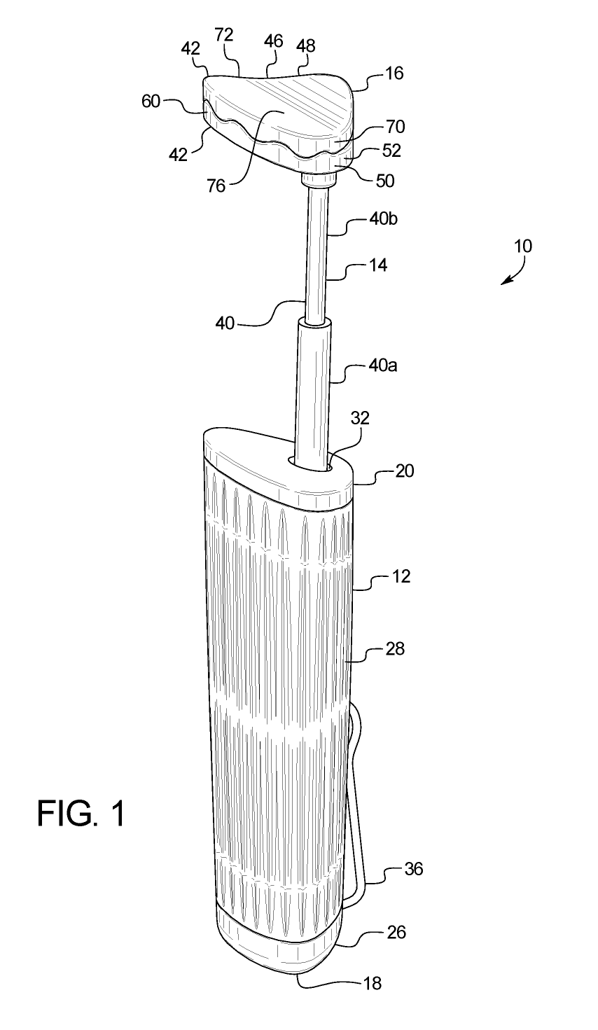

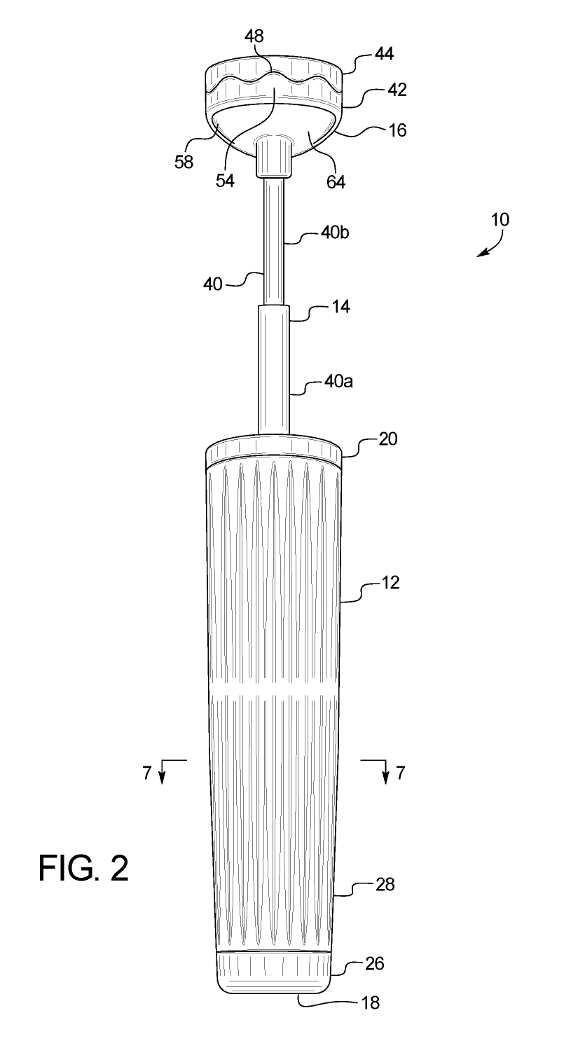

Referring initially to FIGS. 1 and 2, a pet training device 10 is shown. The pet training device 10 can be referred to as a lure sick and includes a handle portion 12, a telescoping shaft 14 and a clip portion 16. The pet training device 10 is configured to hold or carry treats, food, or other objects in the clip portion 16. The pet training device 10 enables a user to insert the desired object or treat into the clip portion 16 and hold the clip portion 16 proximate to the pet using the handle portion 12. The pet can then smell or see the object or treat and be lured in the direction of the training device 10.

The handle portion 12 is generally plastic or rubber and is contoured to be comfortable in the hand of a user. As generally illustrated in FIGS. 1, 3 and 7, the handle portion 12 has a generally tear drop shape with a first end 18 and a second end 20. The tear drop shape forms a first side 22 having an arcuate portion 22a with a large radial curve and a second side 24 with a more narrow radial curve. In one embodiment, the handle can have an inner molded plastic portion 26 that is substantially covered by an outer rubber grip portion 28. The inner molded plastic portion 26 can extend beyond the grip portion 28 at the first and second ends 18 and 20 to enable the grip portion 28 to be securely held onto the outer surface 30 of the molded plastic portion 26. The inner molded plastic portion 26 can have an opening 32 in the second end 20 that enables access into a longitudinal inner bore 34 that is configured to receive the telescoping shaft 14.

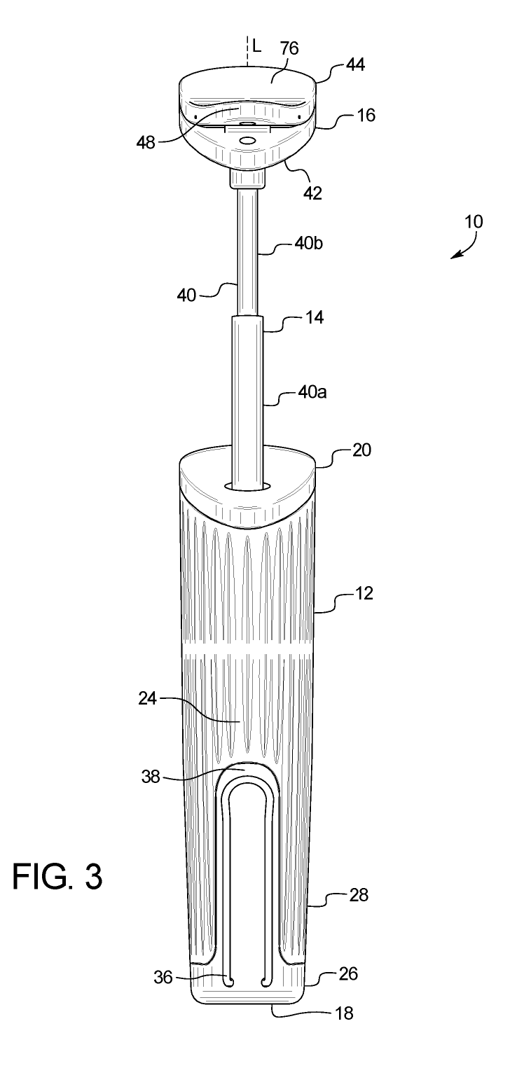

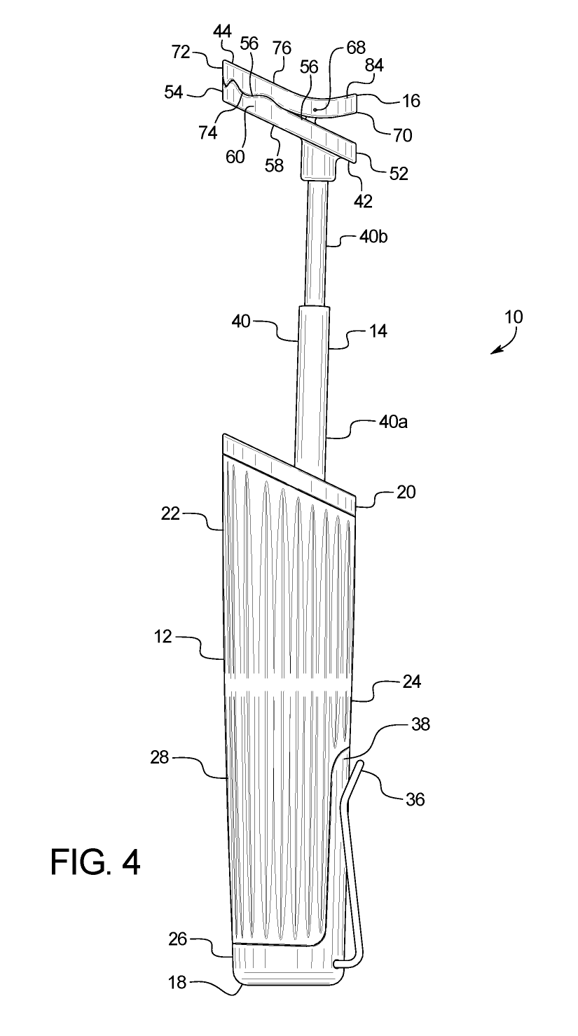

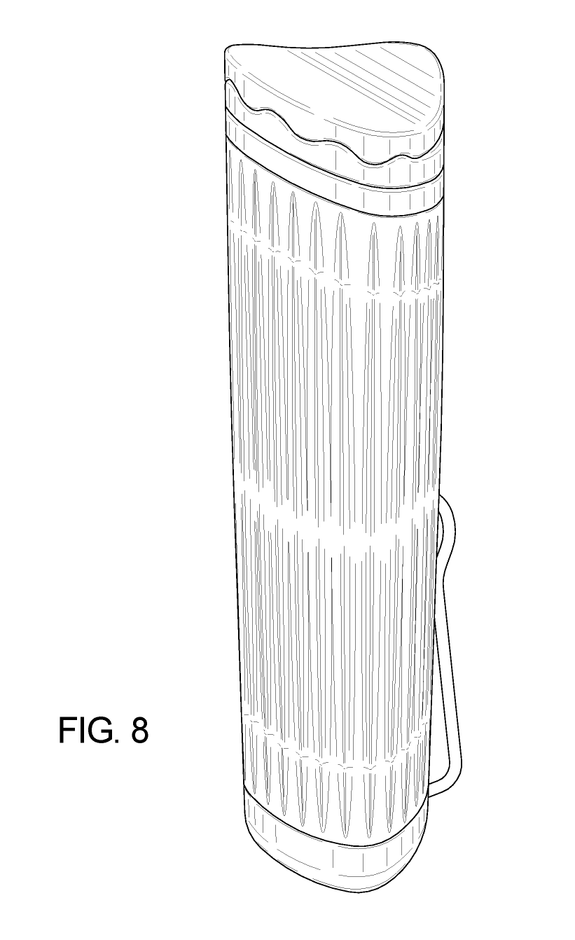

As shown in FIG. 4, the first end 18 is substantially flat, and the second end 20 is angled. The angled second end 20 corresponds to the clip portion 16, such that the clip portion 16 lies flush with the second end 20 in the retracted position (see FIG. 8). The handle portion 12 can include a belt clip 36 to enable the training device 10 to be attached to clipped to the belt of a user or other object. The belt clip 36 is preferably attached at the first end 18 and extends in the longitudinal direction L towards the second end 20. In this embodiment, the clip 36 is a U-shaped metal clip that is disposed along the second side 24, as shown in FIGS. 3, 4 and 6. Additionally, the inner molded plastic portion 26 can extend or protrude from the first end 18 along the second side 24 in the longitudinal direction L toward the second end 20. This protrusion 38 is generally shaped to correspond to (but be slightly larger than) the clip 36. Thus, the clip 36 can overlie the inner molded plastic portion 26. Such a configuration enables the clip 36 to grip or hold material or an object between the clip 36 and the inner molded plastic portion 26 for improved gripping.

The telescoping shaft 14 can include a multiple piece shaft member 40 and is attached to the handle portion 12. The shaft member can include a first shaft member 40a and a second shaft member 40b; however, it is noted that the multiple piece shaft member 40 can be any suitable number of pieces. Additionally, it is noted that the telescoping shaft can 14 be a single piece shaft and can simply retract into the handle portion 12.

In one embodiment, the second shaft member 40b has a diameter than is smaller than the diameter of the first shaft member 40a. Thus, since the first shaft member 40a is generally hallow, the second shaft member is capable of retracting within the first shaft member 40a. As shown in FIGS. 1 and 8, the telescoping shaft 14 is able to extend to an extended state (FIG. 1), and retract to a retracted state (FIG. 8), in which the telescoping shaft 14 is disposed within the bore 34 of the handle portion 12. The telescoping shaft 14 can be formed of any suitable material (such as metal or plastic) and is capable of telescoping to various lengths. As is understood, in one embodiment, when being converted from the extended state to the retracted state, a force is applied to the clip portion 16 or the shaft portion 14 in the longitudinal direction toward the handle portion 12. This force causes the first shaft member 40a to retract into the longitudinal bore 34, and the second shaft member 40b to retract in the first shaft member 40a. The telescoping feature enables the training device 10 to adjust to various size pets, various size users and also to be compact for carrying purposed when not in use.

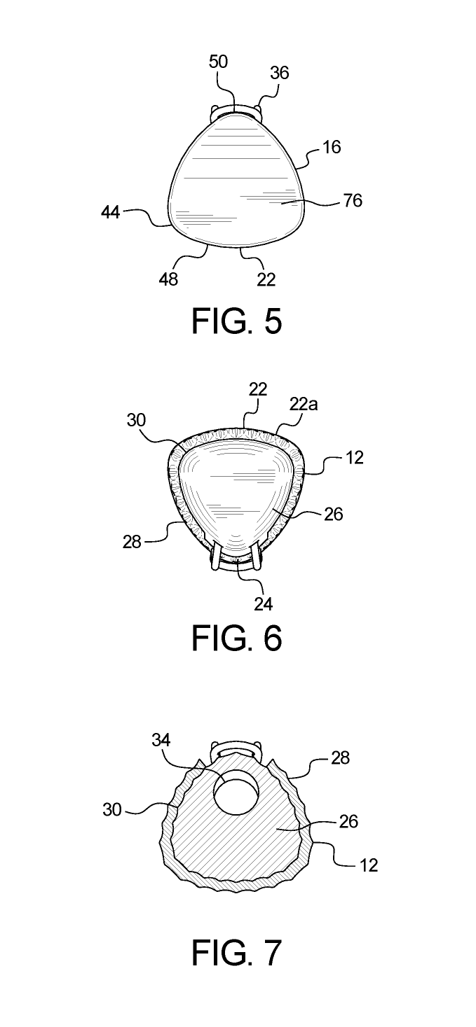

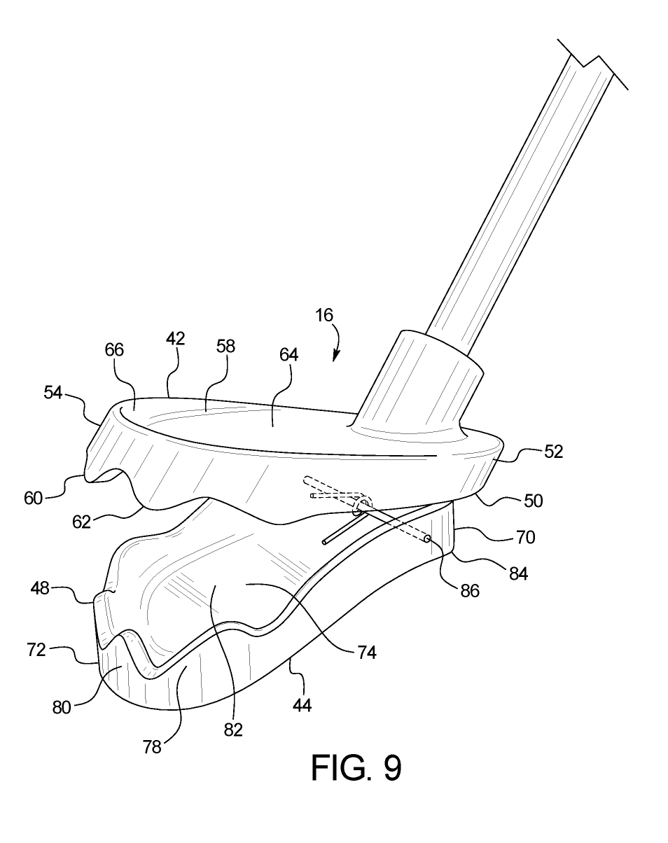

As shown in FIGS. 5 and 9, the clip portion 16 includes a first member 42 and a second member 44 pivotally or hingedly connected to the first member 42. The clip portion 16 has a tear drop shape that corresponds to the handle portion 12 and is coupled to the telescoping shaft 14. Thus, similarly to the handle portion 12 each of the first and second members 42 and 44 of the clip portion 16 has a first side 46 with an arcuate portion 48 with a large radial curve and a second side 50 with a more narrow radial curve.

The first member 42 is preferably a plastic member (or any suitable material) that has a second proximal end 52 on the second side 50 connected to the shaft 14 and a first distal end 54 at the first side 48. The first member 42 has a first surface 46 facing the second member 44 and a second surface 58 facing in a direction opposite the first surface 56. The first surface 56 of the first member 42 is an interior surface and has a wall or ridge 60 that extends upwardly from three sides to define at least a portion of the interior surface 56. The wall or ridge 60 at the distal end 54 is rounded or curved and has teeth or a plurality of protrusions 62 extending therefrom. It is noted that the teeth or protrusions 62 can extend over any portion or all of the wall or ridge 60. The second surface 58 of the first member includes a reservoir or recessed area 64 defined by a wall 66. In one embodiment, the recessed area 64 is generally sloped downwardly toward the distal end 54, such that the distal end 54 defines the deepest portion of the recess 64. The recessed area 64 is configured to hold treats or an object. For example, paste like food (e.g., peanut butter) can be held in the recessed area 66. Preferably, the wall 66 is configured to extend along a uniform height so as to correspond to the second side of the handle portion 12, such that the first member is capable of lying flush with the second end 20 of the handle portion 12.

The second member 44 is preferably plastic and is preferably connected to or coupled to the first member 42 so as to be capable of pivoting relative to the first member 42. The hinged or pivoted connection can be accomplished in any suitable manner including a hinge 68, a thin piece of flexible material or any other suitable manner. The second member 44 includes a second or proximal end 70 at the second side 50 connected to the first member 42 and a first or distal end 72 at the first side 48. The second member 42 has an interior surface 74 facing the first surface 56 of the first member 42 and a second surface 76 facing in a direction opposite the first surface 74. A wall or ridge 78 extends upwardly from three sides of the first surface 74. The distal end 72 is preferably rounded or curved, as described above, and has teeth or a plurality of protrusions 80 extending in the wall or ridge 78. It is noted that the teeth or protrusions 80 can extend over any portion or all of the wall or ridge 78. The teeth or protrusions 62 on the first member 42 are preferably configured to mesh with the teeth or protrusions 80 on the second member 44. Thus, the valleys of the first member teeth or protrusions 62 are adjacent the protrusions or raised areas of the second teeth or plurality of protrusions 80 and vice versa when the clip portion 16 is in a closed state. The first and second member 42 and 44 define an interior space therebetween 82.

The clip portion 16 at the proximal side is upwardly curved. Thus, the second side 70 of the second member 42 forms a tab member 84 that is spaced from the second side 52 of the first member 42. Moreover, the second member 44 is pivotally coupled to the first member 42 at end of the tab 84 member using a pin 86. The pin 86 can extend through the wall of ridge of 78 of the second member 44 and through a protrusion in the first member. This configuration enables the second member to be hingedly connected to the first member and pivot relative thereto around the pin 86. As is shown in FIG. 5, the first surface 74 of the second member 44 is configured to be flush with the first surface 56e of the first member 42 in a closed state, such that the teeth or protrusions 62 and 80 of the first and second members 42 and 44 mesh.

The clip portion 16 can include a biasing member 88 (e.g., a spring) that is arranged around the pin 86 or to operate in conjunction with the pin 86 to bias the first member 42 and the second member 44 to the closed state. Thus, to move the clip portion 16 to the open state, the biasing force of the biasing member 88 must be overcome. The biasing force can be overcome by exerting a downward force on the tab member 84 in a direction toward the first member 42. This force will cause the second member 44 to pivot around the pin 84 and move the first surface 74 of the second member 42 away from the first surface 56 of the first member 42 and separate the teeth or protrusions 62 and 80 of the first and second members 42 and 44 of the first and second members. The biasing force can be any suitable force and can simply be a small force that attempts to maintain the clip portion 16 in the closed state.

In operation, a user can insert a treat or other object into the interior area 82 between the first member 42 and the second 44 by moving the second member 44 away from the first member 44 in a pivoting manner. In other words, the biasing force of the biasing member 88 can be overcome the clip portion 16 can be moved from the closed state to an open state. The treat or other object is inserted between the first member 42 and the second member 44 and held by the teeth or protrusions 62 and 80 and the biasing member 88, which will attempt to move the clip portion 16 into the closed state.

Alternatively or in conjunction, the user can insert a paste like material into the reservoir in the second member 44.

The user can then adjust the telescoping shaft 14 to the desired length and position the clip portion 16 adjacent the pet. The pet will then smell or see the object/treat/food disposed in the clip portion 16 and be lured in the direction of the clip portion 16. This luring can then be used to train the pet to perform the desired activity or move in the desired direction. When not in use, the user can simply retract the telescoping shaft 14 to the closed position, as shown in FIG. 8.

The pet can at any desired time be allowed to consume the treat/food or obtain the object in the clip portion 16. The clip portion 16 is configured to enable the pet to obtain the toy or consume the treat/food. For example, the biasing force of the biasing member 88 can be such that the pet is easily able to remove the object or treat between the first and second members 42 and 44. Alternatively, the biasing force can be such that the pet must “work” to remove the treat or object.

Further the recessed area 64 in the first portion 42 is arranged to enable easy access for the pet to consume the paste like substance form the recessed area 64.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “portion” or “element” when used in the singular can have the dual meaning of a single part or a plurality of parts. Accordingly, these terms, as utilized to describe the present invention should be interpreted relative to a pet training device.

The terms of degree such as “generally” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A pet training device comprising:
a telescoping shaft; and
a clip portion, the clip portion has a first member and a second member pivotally connected to the first member so as to be capable of holding an object therebetween in an interior area, the second member includes a reservoir portion on an external surface that enables food to be disposed therein.

2. The pet training device of claim 1, wherein
the first member includes first teeth and the second member includes second teeth configured to mesh with first teeth.

3. The pet training device of claim 1, wherein
the second member is pivotally connected to the first member by a pin.

4. The pet training device of claim 3, wherein
the pin is disposed at a proximal end.

5. The pet training device of claim 3, wherein
a biasing member is disposed to pivot the second member around the pin.

6. The pet training device of claim 3, wherein
the second member includes a tab disposed at a proximal end, the tab configured to enable the second member to be pivoted around the pin to an open position.

7. The pet training device of claim 6, wherein
a biasing member biases the second member into a closed position.

8. The pet training device of claim 1, wherein
the reservoir is defined by a wall extending from a surface of the second member.

9. The pet training device of claim 1, wherein
the reservoir has a first portion adjacent a distal end and a second portion adjacent the proximal end, the first portion being deeper than the second portion.

10. The pet training device of claim 1, further comprising
a handle portion having a first end and a second end.

11. The pet training device of claim 10, wherein
the first member is configured to fit flush against the second end of the handle portion in a retracted position.

12. The pet training device of claim 10, wherein
the handle portion includes a U-shaped clip connected adjacent the first end.

13. The pet training device of claim 10, wherein
the handle portion includes a bore configured to receive the telescoping shaft.

14. The pet training device of claim 10, wherein
the handle portion includes an inner plastic molded portion and a rubber grip.
